(19) United States
(12) Patent Application Publication
(10) Pub. No.: US 2026/0184540 A1
(43) Pub. Date: Jul. 2, 2026

(54) MONITORING TRAVELING CABLE MOVEMENTS

(71) Applicant: Otis Elevator Company, Farmington, CT (US)

(72) Inventors: YiSug Kwon, Farmington, CT (US); Jinho Song, Farmington, CT (US); Seungbo Kim, Avon, CT (US); Jungho Ha, Ilsan/Goyang-si (KR)

(21) Appl. No.: 19/003,398

(22) Filed: Dec. 27, 2024

(51) Int. Cl. B66B 7/06

(52) U.S. Cl. CPC B66B 7/064; B66B 2201/235

(57) ABSTRACT

A controller for monitoring and controlling an elevator system, where the controller is operable to perform controller operations that include receiving machine-readable sensor output generated in response to movement of a traveling cable within a hoistway. The machine-readable sensor output is analyzed to determine a traveling cable operating condition. Responsive to a determination that the traveling cable operating condition includes a first type of traveling cable operating condition, an alert operation is executed. Responsive to a determination that the traveling cable operating condition includes a second type of traveling cable operating condition, an elevator control operation is executed. The elevator control operation is operable to reduce the movement of the traveling cable within the hoistway.

### BACKGROUND

The embodiments described herein relate to an elevator system and more specifically to elevator systems having electronic measurement and control systems operable to monitor, detect and respond to unwanted traveling cable movements.

Elevator systems can include an elevator car and counterweight that are suspended within a hoistway by roping that includes one or more load bearing members. In some elevator system configurations, a plurality of ropes, cables or belts are used for supporting the weight of the elevator car and the counterweight, as well as for moving the elevator car to desired positions within the hoistway. The load bearing members are typically routed about several sheaves according to a desired roping arrangement. Tie down compensation of the elevator system relies on a chain or roping beneath the elevator and the counterweight to manage and mitigate the effects of elevator car movement, particularly in relation to vertical and horizontal forces, to ensure that the elevator car remains stable and properly aligned with the landing doors during operation.

Elevator systems also include one or more flexible traveling cables positioned within the hoistway to connect a stationary electrical supply and control systems to the moving parts of the elevator system, including the elevator car. A traveling cable is typically formed as multiple flexible conductors housed in a flexible protective outer sheath and is designed to withstand the movement and bending imparted to traveling cables under normal elevator system operating conditions.

Building sway refers to the lateral movement or oscillation of a structure, typically caused by external forces such as wind, earthquakes, or other dynamic loads. Building sway is particularly relevant in tall buildings and skyscrapers, where the effects of these external forces can be more pronounced due to building height and building flexibility. Building sway is an abnormal elevator system operating condition that can induce undesirable levels of sway in elevator system components, including traveling cables. Such undesirable levels of traveling cable sway can result in traveling cables contacting hoistway walls and/or unnetted hoistway structures, thereby damaging the unnetted hoistway structure, the traveling cable, or both. This damage can lead to unsafe operating conditions, such as the elevator system not responding correctly to commands.

Although detected building sway is an indicator of the potential for an undesirable level of sway to develop in elevator system components, using building sway aa a proxy for sway in elevator system components can be insufficient because there are other abnormal elevator system operating conditions that can cause sway in elevator system components, including, for example, the stack effect and/or the piston effect. The stack effect refers to an elevator system operating condition in which air pressure and temperature between different levels of a building create airflow that can induce undesirable levels of sway in traveling cables. The piston effect refers to an elevator system operating condition in which the movement of an elevator car creates changes in air pressure within the hoistway, similar to how a piston operates in a cylinder. Thus, the piston effect can also create airflow that can induce undesirable levels of sway in traveling cables.

### BRIEF SUMMARY

Disclosed is a controller for monitoring and controlling an elevator system, where the controller is operable to perform controller operations that include receiving machine-readable sensor output generated in response to movement of a traveling cable within a hoistway. The machine-readable sensor output is analyzed to determine a traveling cable operating condition. Responsive to a determination that the traveling cable operating condition includes a first type of traveling cable operating condition, an alert operation is executed. Responsive to a determination that the traveling cable operating condition includes a second type of traveling cable operating condition, an elevator control operation is executed, where the elevator control operation is operable to reduce the movement of the traveling cable within the hoistway.

In addition to one or more aspects of the controller or as an alternative, the machine-readable sensor output is generated by a sensor physically coupled to the traveling cable.

In addition to one or more aspects of the controller or as an alternative, the sensor receives power from a power conductor of the traveling cable.

In addition to one or more aspects of the controller or as an alternative, the machine-readable sensor output is generated by a non-contact displacement sensor.

In addition to one or more aspects of the controller or as an alternative, the machine-readable sensor output is generated by a sensor; a first end of the traveling cable is electronically coupled to an elevator car of the elevator system; and a second end of the traveling cable is physically coupled to the sensor.

In addition to one or more aspects of the controller or as an alternative, the controller includes a machine learning model.

In addition to one or more aspects of the controller or as an alternative, the determination that the traveling cable operating condition includes the first type of traveling cable operating condition is performed by the machine learning model. Additionally, the determination that the traveling cable operating condition includes the first type of traveling cable operating condition includes a first prediction of a first type of future movement of the traveling cable within the hoistway.

In addition to one or more aspects of the controller or as an alternative, the determination that the traveling cable operating condition includes the second type of traveling cable operating condition is performed by the machine learning model. Additionally, the determination that the traveling cable operating condition includes the second type of traveling cable operating condition includes a second prediction of a second type of movement of the traveling cable within the hoistway, as well as a third prediction that the second type of movement of the traveling cable within the hoistway will result in damage to the traveling cable.

In addition to one or more aspects of the controller or as an alternative, the determination that the traveling cable operating condition includes the first type of traveling cable operating condition includes a determination that the machine-readable sensor output exceeds a first threshold.

In addition to one or more aspects of the controller or as an alternative, the determination that the traveling cable operating condition includes the second type of traveling cable operating condition includes a determination that the machine-readable sensor output exceeds a second threshold.

Disclosed is an elevator system that includes a traveling cable and a controller. The traveling cable is physically and electronically coupled to an elevator car, where the traveling cable and the elevator car are configured to operate within a hoistway. The controller is operable to perform controller operations that include receiving machine-readable sensor output generated in response to movement of the traveling cable within the hoistway. The controller operations include analyzing the machine-readable sensor output to determine a traveling cable operating condition. Responsive to a determination that the traveling cable operating condition includes a first type of traveling cable operating condition, an alert operation is executed. Responsive to a determination that the traveling cable operating condition includes a second type of traveling cable operating condition, an elevator control operation is executed, where the elevator control operation is operable to reduce the movement of the traveling cable within the hoistway.

In addition to one or more aspects of the elevator system or as an alternative, the machine-readable sensor output is generated by a sensor; the sensor receives power from a power conductor of the traveling cable; and the sensor is selected from the group consisting of a displacement sensor and an accelerometer.

In addition to one or more aspects of the elevator system or as an alternative, the machine-readable sensor output is generated by a sensor, and the sensor includes an accelerometer.

In addition to one or more aspects of the elevator system or as an alternative, the controller includes a machine learning model. The determination that the traveling cable operating condition includes the first type of traveling cable operating condition is performed by the machine learning model. The determination that the traveling cable operating condition includes the first type of traveling cable operating condition includes a first prediction of a first future movement of the traveling cable within the hoistway. The determination that the traveling cable operating condition includes the second type of traveling cable operating condition is performed by the machine learning model. The determination that the traveling cable operating condition includes the second type of traveling cable operating condition includes a second prediction and a third prediction. The second prediction is of a second type of movement of the traveling cable within the hoistway. The third prediction is that the second type of movement of the traveling cable within the hoistway will result in damage to the traveling cable.

In addition to one or more aspects of the elevator system or as an alternative, the determination that the traveling cable operating condition includes the first type of traveling cable operating condition includes a determination that the machine-readable sensor output exceeds a first threshold; and the determination that the traveling cable operating condition includes the second type of traveling cable operating condition includes a determination that the machine-readable sensor output exceeds a second threshold. The first threshold is less than the second threshold.

Disclosed is a computer-implemented method that includes receiving, using a processor system, machine-readable sensor output generated in response to movement of a traveling cable within a hoistway. The computer-implemented method further includes analyzing the machine-readable sensor output to determine a traveling cable operating condition. Responsive to a determination that the traveling cable operating condition includes a first type of traveling cable operating condition, an alert operation is executed. Responsive to a determination that the traveling cable operating condition includes a second type of traveling cable operating condition, an elevator control operation is executed, where the elevator control operation is operable to reduce the movement of the traveling cable within the hoistway.

In addition to one or more aspects of the computer-implemented method or as an alternative, the machine-readable sensor output is generated by a sensor selected from the group consisting of a displacement sensor and an accelerometer.

In addition to one or more aspects of the computer-implemented method or as an alternative, the processor system includes a machine learning model. The determination that the traveling cable operating condition includes the first type of traveling cable operating condition is performed by the machine learning model. The determination that the traveling cable operating condition includes the first type of traveling cable operating condition includes a first prediction of a first future movement of the traveling cable within the hoistway. The determination that the traveling cable operating condition includes the second type of traveling cable operating condition is performed by the machine learning model. The determination that the traveling cable operating condition includes the second type of traveling cable operating condition includes a second prediction and a third prediction. The second prediction is of a second type of movement of the traveling cable within the hoistway. The third prediction is that the second type of movement of the traveling cable within the hoistway will result in damage to the traveling cable.

In addition to one or more aspects of the computer-implemented method or as an alternative, the determination that the traveling cable operating condition includes the first type of traveling cable operating condition includes a determination that the machine-readable sensor output exceeds a first threshold.

In addition to one or more aspects of the computer-implemented method or as an alternative, the determination that the traveling cable operating condition includes the second type of traveling cable operating condition includes a determination that the machine-readable sensor output exceeds a second threshold.

### BRIEF DESCRIPTION OF THE DRAWINGS

The present disclosure is illustrated by way of example and not limited in the accompanying figures in which like reference numerals indicate similar elements.

FIG. 1 is a simplified schematic illustration of an elevator system operable to employ embodiments of the disclosure;

FIG. 2 is a simplified schematic illustration of a sensor-based system operable to employ embodiments of the disclosure;

FIG. 3 is a simplified schematic illustration of another elevator system operable to employ embodiments of the disclosure;

FIG. 4 is a simplified schematic illustration of another elevator system operable to employ embodiments of the disclosure;

FIG. 5 is a simplified schematic illustration of another elevator system operable to employ embodiments of the disclosure;

FIG. 6 is a simplified schematic illustration of a side view and a top-down view of a traveling cable operable to employ embodiments of the disclosure;

FIG. 7A is a flow diagram illustrating a computer-implemented methodology in accordance with embodiments of the disclosure;

FIG. 7B is a simplified schematic further illustrating aspects of the methodology shown in FIG. 7A in accordance with embodiments of the disclosure;

FIG. 8A illustrates training operations for generating a machine learning prediction/classification model operable to employ embodiments of the disclosure;

FIG. 8B illustrates a machine learning prediction/classification model that results from the training operations depicted in FIG. 8A;

FIG. 9A depicts a machine learning system that can be utilized to implement embodiments of the disclosure;

FIG. 9B depicts a learning phase that can be implemented by the machine learning system shown in FIG. 9A; and

FIG. 10 depicts a computer system that can be utilized to implement embodiments of the disclosure.

### DETAILED DESCRIPTION

Embodiments of the disclosure provide electronic control systems operable to monitor, detect, analyze and respond to undesirable levels of movement or sway in traveling cables of elevator systems. The undesirable level of traveling cable sway includes sway that is sufficient to cause the traveling cable to contact hoistway walls and/or unnetted hoistway structures, thereby causing damage to the hoistway structures, the traveling cables, or both. By detecting and analyzing actual movements of traveling cables, embodiments of the disclosure can address undesirable levels of traveling cable sway in a predictive manner and regardless of the building conditions or elevator system operating conditions that cause the undesirable level of traveling cable sway.

In some embodiments of the disclosure, the elevator system includes an electronic monitoring and compensation (M&C) system configured to receive machine-readable sensor outputs from one or more cable sway sensors, which are sensors configured and arranged to monitor and detect movements of a traveling cable of an elevator system operating inside a hoistway. The M&C system performs analysis on the machine-readable sensor output to determine the traveling cable's operating condition. Where the analysis performed by the M&C system results in a determination that the traveling cable operating condition includes a first type of traveling cable operating condition, the M&C system executes an alert operation. The first type of traveling cable operating condition is traveling cable movements or a pattern of traveling cable movements that indicate likely traveling cable or hoistway structure damage in the future but also indicates that there is sufficient time to alert an expert and have the expert conduct an investigation of the relevant elevator system. Where the analysis performed by the M&C system results in a determination that the traveling cable operating condition includes a second type of traveling cable operating condition, the M&C system executes an elevator control operation operable to reduce the movement of the traveling cable within the elevator hoistway. The second type of traveling cable operating condition is traveling cable movements or a pattern of traveling cable movements that indicate likely traveling cable or hoistway structure damage in the future and also indicates that immediate corrective action is needed because there is insufficient time to alert an expert and have the expert conduct an investigation of the relevant elevator system.

In some embodiments of the disclosure, the M&C system includes machine learning models operable to perform the determination that the traveling cable operating condition includes a first type of traveling cable operating condition, as well as the determination that the traveling cable operating condition includes a second type of traveling cable operating condition. In some embodiments of the disclosure, the machine learning models are prediction and/or classification models. In some embodiments of the disclosure, the machine learning models are prediction and/or classification models of the traveling cable trained to perform the task of determining that the traveling cable operating condition includes the first type of traveling cable operating condition. In some embodiments of the disclosure, the determination that the traveling cable operating condition includes the first type of traveling cable operating condition includes the machine learning model making a first prediction of a first type of future movement of the traveling cable within the elevator hoistway. The first type of future movement of the traveling cable within the elevator hoistway can be a traveling cable movement that merits executing the alert operation but does not yet merit executing the elevator control operation operable to reduce the movement of the traveling cable within the elevator hoistway.

In some embodiments of the disclosure, the machine learning models are further trained to perform the task of determining that the traveling cable operating condition includes the second type of traveling cable operating condition. In some embodiments of the disclosure, the determination that the traveling cable operating condition includes the second type of traveling cable operating condition includes a second prediction and a third prediction. The second prediction predicts that a second type of movement of the traveling cable is occurring within the elevator hoistway; and the third prediction predicts that the second type of movement of the traveling cable within the hoistway will in the future result in damage to the traveling cable. In some embodiments of the disclosure, the determination that that the traveling cable operating conditions include the second type of traveling cable operating condition includes a prediction that the movement of the traveling cable within the elevator hoistway will result in damage to the traveling cable within a predetermined period of time and also indicates that immediate corrective action is needed because the predetermined period of time is insufficient to alert an expert and have the expert conduct an investigation of the relevant elevator system. Thus, the second type of movement of the traveling cable within the elevator hoistway can be a traveling cable movement that merits executing the elevator control operation operable to reduce the movement of the traveling cable within the elevator hoistway.

In some embodiments of the disclosure, the determination that the traveling cable operating condition includes the first type of traveling cable operating condition includes a determination that the machine-readable sensor output exceeds a first threshold. In some embodiments of the disclosure, the first threshold represents a traveling cable movement that merits executing the alert operation but does not yet merit executing the elevator control operation operable to reduce the movement of the traveling cable within the elevator hoistway.

In some embodiments of the disclosure, the determination that the traveling cable operating condition includes the second type of traveling cable operating condition includes a determination that the machine-readable sensor output exceeds a second threshold. In some embodiments of the disclosure, the second threshold represents a traveling cable movement that merits executing the elevator control operation operable to reduce the movement of the traveling cable within the elevator hoistway. In embodiments of the disclosure, the traveling cable movement represented by the first threshold is less than the traveling cable movement represented by the second threshold. In embodiments of the disclosure, the first threshold is less than the second threshold. In some embodiments of the disclosure the first threshold and the second threshold are set by technicians and/or subject matter experts having experience with the details of monitoring, detecting, and responding to unwanted traveling cable movements.

In some embodiments of the disclosure, the machine-readable sensor output is generated by a sensor physically coupled to the traveling cable. In some embodiments of the disclosure, the sensor is physically coupled to the traveling cable and electronically coupled to a power conductor of the traveling cable. In some embodiments of the disclosure, the machine-readable sensor output is generated by a sensor that includes but is not limited to a wireless sensor, non-contact displacement sensor, and an accelerometer.

The various components of the electronic control systems disclosed herein are configured and arranged to monitor, detect, analyze and respond to undesirable levels of movement or sway in traveling cables of elevator systems in real time by incorporating real time signal processing techniques. Real time signal processing utilizes various algorithms operable to optimize speed and efficiency, including, for example, filtering algorithms, fast Fourier transform (FFT) algorithms, adaptive filtering, wavelet transforms, compression algorithms, machine learning algorithms, signal detection algorithms, Kalman filters, and the like. These algorithms are designed to minimize latency and maximize throughput to ensure that the various components of the electronic control systems disclosed herein can process incoming data without delays. Implementations of the above-described algorithms can also incorporate efficient coding practices and optimized hardware, such as digital signal processors (DSPs) or field programmable gate arrays (FPGAs), to meet real-time constraints.

Thus, the embodiments of the disclosure described herein provide a comprehensive and real-time approach to addressing unwanted levels of sway in traveling cables by monitoring, detecting, analyzing and responding to actual traveling cable movements. By monitoring, detecting, and analyzing actual traveling cable movements, embodiments of the disclosure provide the ability to respond to unwanted levels of traveling cable movement regardless of the traveling cable operating condition that is causing unwanted levels of traveling cable movement. Although detected building sway is an indicator of the potential for unwanted levels of sway to develop in elevator system components, there are other abnormal elevator system operating conditions that can induce sway in elevator system components, including, for example, the stack effect or the piston effect. The stack effect refers to an elevator operating condition in which air pressure and temperature between different levels of a building create airflow that can induce sway in traveling cables. The piston effect refers to an operating condition in which the movement of an elevator car creates changes in air pressure within the hoistway, similar to how a piston operates in a cylinder. The airflow created by the piston effect can also induce sway in traveling cables.

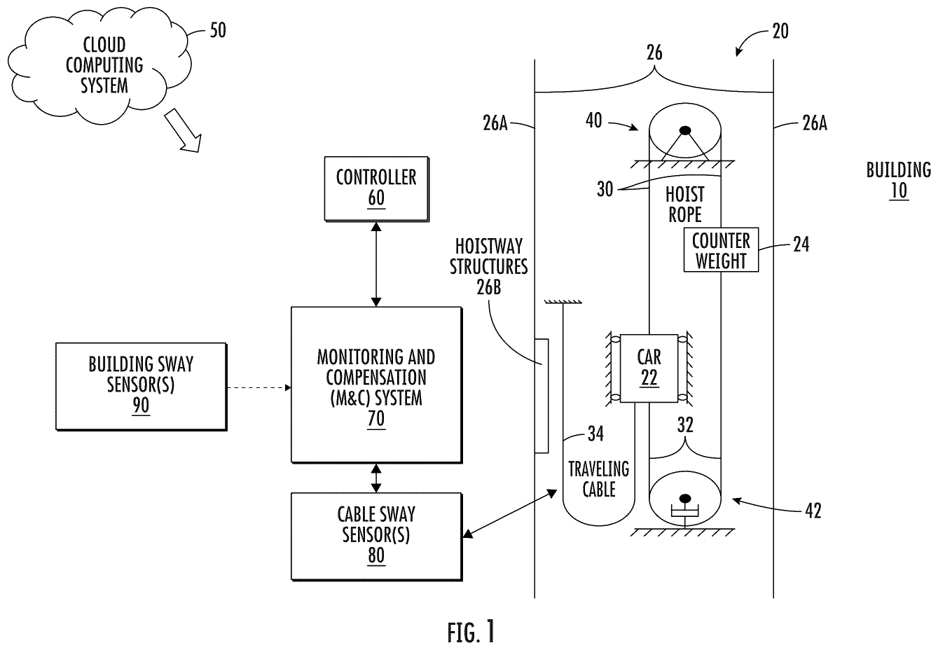

Turning now to a more detailed description of embodiments of the disclosure, FIG. 1 schematically shows selected portions of an elevator system 20 operable to employ embodiments of the disclosure. The elevator system 20 is within a building 10 and includes an elevator car 22 and counterweight 24 moveable within a hoistway 26 in a known manner. The hoistway 26 includes inner hoistway walls 26A. A variety of hoistway structures 26B are positioned along the hoistway walls 26A, including, for example unnetted guide rails and regions in the landing door areas of the hoistway 26. The structures 26B can be located anywhere along the hoistway walls 26A. The elevator car 22 and counterweight 24 are supported by a load bearing assembly including motor-driven sheaves (or pulleys) 40, 42, as well as roping or belts (e.g., hoist ropes 30 and tie down compensation members 32) that support the weight of the elevator car 22 and counterweight 24 and provide for moving them in a known manner. The hoist ropes 30 support bearing loads (e.g., the elevator car 22 and the counterweight 24) to facilitate vertical movement, guidance and stability of the elevator car 22 in a known manner. The tie down compensation member 32 is associated with the elevator car 22 and the counterweight 24 to provide tie down compensation in a known manner. A traveling cable 34 provides for communicating electrical power and signals between components associated with the elevator car 22 and at least one other device typically located in a fixed position relative to the hoistway 26. The fixed position relative to the hoistway 26 can be a location along the hoistway wall 26B that is substantially a midpoint of the allowed travel distance of the elevator car 22 within the hoistway 26.

Each of the hoist ropes 30, the tie down compensation member 32, and the traveling cable 34 is an elongated vertical member within the hoistway 26. Any one or more of the elongated vertical members 30, 32, 34 can begin to sway within the hoistway 26 if appropriate conditions conducive to sway exist. Building sway is known to induce sway of an elongated vertical member within a hoistway especially when the frequency of the building sway is an integer multiple of a natural frequency of the elongated member. Unlike the hoist ropes 30 and the tie down compensation member 32, which are constrained by the motor-driven sheaves (or pulleys) 40, 42, the traveling cable 34 must have a significant degree of freedom of motion to allow it to travel with the elevator car 22. Accordingly, the traveling cable 34 is more susceptible to being induced to sway than hoist ropes 30 and tie down compensation members 32 because the traveling cable 34 is not substantially restrained other than its connection at one end to the elevator car 22 and at another end to the fixed location (e.g., along the hoistway wall 26A). Thus, the traveling cable 34 is highly susceptible being induced to sway by sources beyond building sway, such as, for example, the stack effect or the piston effect. Even in the absence of building sway, other conditions conducive to sway can cause the traveling cable 34 to have sufficient levels of sway that the traveling cable 34 contacts unnetted or otherwise exposed instances of the hoistway structures 26B, which can cause damage to the unnetted or otherwise exposed instances of the hoistway structures 26B, the traveling cable 34, or both.

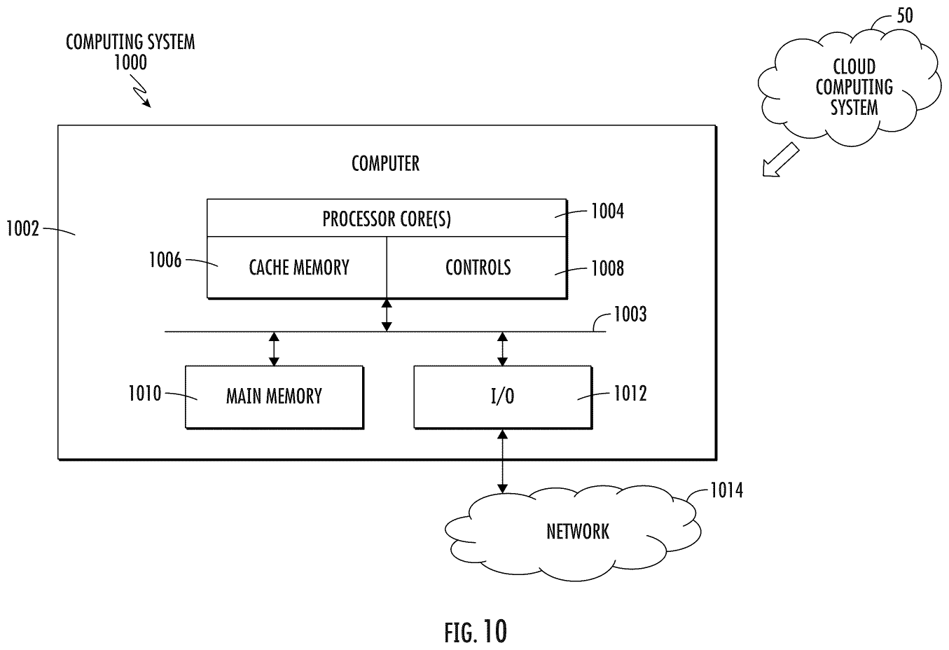

The elevator system 20 further includes a controller 60. The controller 60 can be located external to the hoistway 26 or inside a secure machine room (not shown separately) of the hoistway 26. The controller 60 is configured to control the various operations of the elevator system 20, including particularly the various electronic functionality used by the elevator car 22. The controller 60 can be implemented using the features and functionality of the computer system 1000 (shown in FIG. 10) programmed to perform the various control operations required by the elevator system 20. For example, the controller 60 is operable to provide drive signals to the elevator system 20 to control the acceleration, deceleration, leveling, stopping, etc. of the elevator car 22. When moving up or down within the hoistway 26 along guide rails (not shown separately), the elevator car 22 can stop at one or more landings (not shown separately) as controlled by the controller 60. Additionally, the controller 60 can incorporate data storage and retrieval (DSR) functionality. DSR functionality, in the context of an elevator system, manages the collection, storage, and analysis of data related to elevator operation. DSR functionality monitors performance, ensures safety, and optimizes functionality.

The controller 60 can also incorporate or be connected to a position reference system (not shown separately from the controller 60). If it is not integrated with the controller 60, the position reference system can be mounted at any suitable fixed position as known in the art, such as at the top of the hoistway 26 or on one or more support rails or guide rail, and can be configured to provide position signals related to a position of the elevator car 22, the counterweight 24, and other components of the elevator system 20 within the hoistway 26. The position reference system can be any device or mechanism for monitoring a position of an elevator car and/or counterweight, as known in the art. For example, and without limitation, the position reference system can be an encoder, sensor, or other system and can include velocity sensing, absolute position sensing, etc., as will be appreciated by those of skill in the art. The position reference system provides data to the DSR functionality to assist with monitoring performance, ensuring safety, and optimizing functionality.

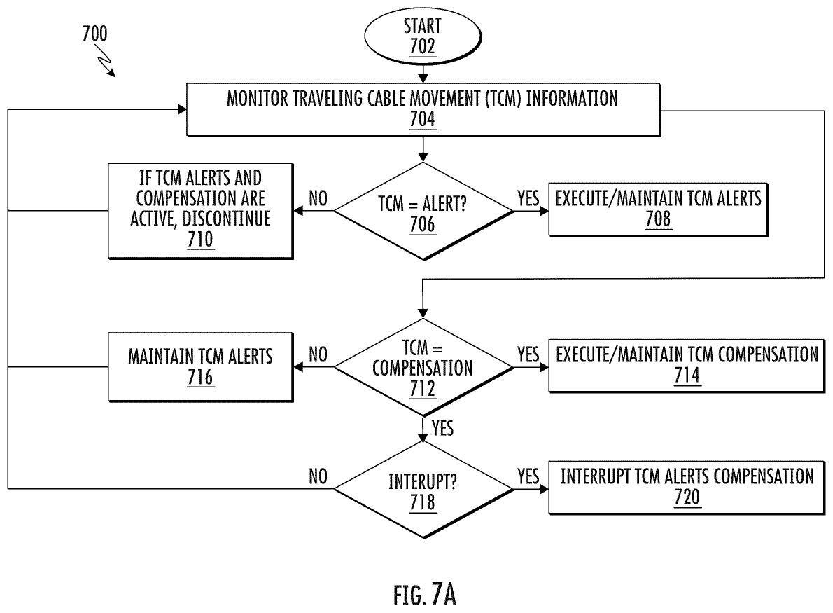

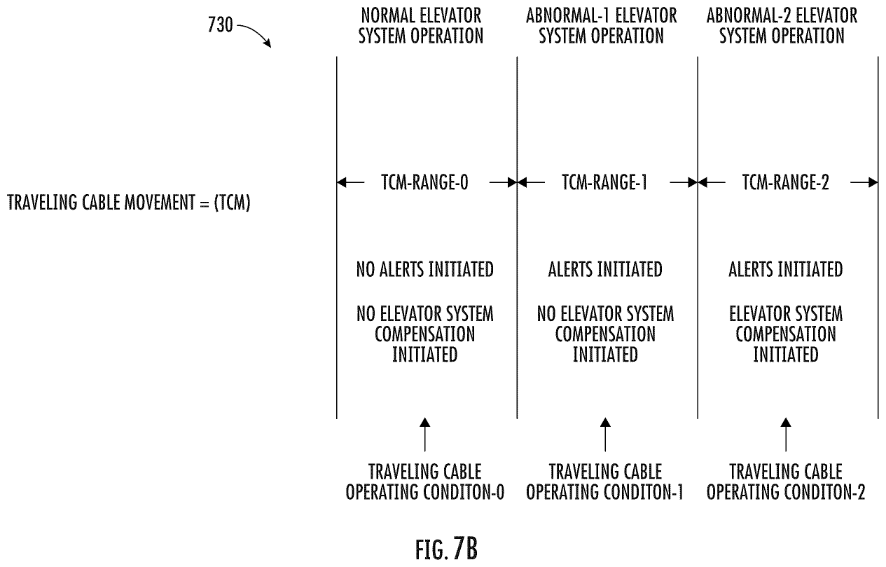

In accordance with embodiments of the disclosure, the elevator system 20 includes a monitoring and compensation (M&C) system 70, which is configured to receive machine-readable sensor output from one or more cable sway sensors 80. Each cable sway sensor 80 is configured and arranged to generate the machine-readable sensor output responsive sensing actual movement of the traveling cable 34 within the hoistway 26. The M&C system 70 can be implemented using the features and functionality of the computer system 1000 (shown in FIG. 10) programmed to perform the various control operations to monitor, detect, analyze, and respond to actual movements of the traveling cable 34. A non-limiting example of how the M&C system 70 can be programmed to perform the various control operations to monitor, detect, analyze, and respond to actual movements of the traveling cable 34 is depicted by the methodology 700, which is shown in FIG. 7A and described in greater detail subsequently herein.

Responsive to a determination that the machine-readable sensor output represents a first operating condition of the traveling cable 34, the M&C system 70 executes an alert operation (e.g., through the controller 60). In embodiments of the disclosure, the first operating condition corresponds to the Traveling Cable Operating Condition-1 shown in FIG. 7B. In some embodiments of the disclosure, the first operating condition is displacement activity (e.g., level of sway) of the traveling cable 34 that includes a displacement pattern that is likely to, if it continues, bring the traveling cable 34 into contact with hoistway walls 26A and/or hoistway structures 26B, which can result in damage to the unnetted or otherwise exposed instances of the hoistway structures 26B, the traveling cable 34, or both at a time that is sufficiently into the future (e.g., about two (2) hours from making the determination) that there is sufficient time to initiate and complete an expert evaluation of the elevator system 20 (e.g., through transmitting to one or more experts alerts and any additional information derived from the machine-readable sensor output).

In some embodiments of the disclosure, a time stamp can be included with the machine-readable sensor output, and the estimate of when the displacement pattern brings the traveling cable 34 into contact with hoistway walls 26A and/or hoistway structures 26B can be based on the machine-readable sensor output time stamp. For example, the previously-described estimate that the displacement pattern will bring the traveling cable 34 into contact with hoistway walls 26A and/or hoistway structures 26B “about two (2) hours from the determination” can be “about two (2) hours from the associated machine-readable sensor output timestamp.”

In some embodiments of the disclosure, the M&C system 70 analyzes the displacement activity over time such that the displacement activity (or the displacement pattern) of the traveling cable 34 includes a rate of increase in the displacement of the traveling cable 34 over time. For example, the M&C system 70 can know a resting or steady state location or displacement activity of the traveling cable 34, and the machine-readable sensor output can represent a displacement of the traveling cable 34 from the resting or steady state location or displacement activity of the traveling cable 34. In this example, the M&C system 70 can determine that a displacement of the traveling cable 34 from the resting or steady state location or displacement activity of the traveling cable 34 is 5/10^{th} of a meter, the rate of change of this displacement of the traveling cable 34 is increasing at a rate of 1/10^{th} of a meter per hour, and the clearance from the resting or steady state location or displacement activity of the traveling cable 34 to the hoistway wall 26A and/or an unnetted or otherwise exposed hoistway structure 26B is about two (2) meters.

In some embodiments of the disclosure, if the M&C system 70 determines that displacement of the traveling cable 34 from the resting or steady state location or displacement activity of the traveling cable 34 is insufficient to represent the first operating condition, the M&C system 70 can determine that the detected displacement substantially represents the movement and bending that occurs in the traveling cable 34 responsive to normal movements and operations of the elevator system 20. In embodiments of the disclosure, displacement of the traveling cable 34 from the resting or steady state location or displacement activity of the traveling cable 34 that is insufficient to represent the first operating condition corresponds to the Traveling Cable Operating Condition-0 shown in FIG. 7B.

Responsive to a determination that the machine-readable sensor output represents a second operating condition of the traveling cable 34, the M&C system 70 executes an elevator control operation (e.g., through the controller 60 and the elevator system 20) operable to adjust operation of the elevator system 20 to reduce the movement of the traveling cable 34 within the hoistway 26. In embodiments of the disclosure, the second operating condition corresponds to the Traveling Cable Operating Condition-2 shown in FIG. 7B. In some embodiments of the disclosure, the second operating condition is displacement activity (e.g., level of sway) of the traveling cable 34 that includes a displacement pattern that qualifies as an emergency situation that warrants immediately changing an operation of the elevator system to reduce the displacement of the traveling cable 34.

In some embodiments of the disclosure, the M&C system 70 analyzes the displacement activity over time such that the displacement activity (or the displacement pattern) of the traveling cable 34 includes a rate of increase in the displacement of the traveling cable 34 over time. For example, the M&C system 70 can know a resting or steady state location or displacement activity of the traveling cable 34, and the machine-readable sensor output can represent a displacement of the traveling cable 34 from the resting or steady state location or displacement activity of the traveling cable 34. In this example, the M&C system 70 can determine that a displacement of the traveling cable 34 from the resting or steady state location or displacement activity of the traveling cable 34 is 1 and 8/10^{th} of a meter, the rate of change of this displacement of the traveling cable 34 is increasing at a rate of 1/10^{th} of a meter per hour, and the clearance from the resting or steady state location or displacement activity of the traveling cable 34 to the hoistway wall 26A and/or an unnetted or otherwise exposed hoistway structure 26B is about two (2) meters. Under this example of the second operating conditions, damage to the traveling cable 34 and/or the hoistway structures 26B is imminent (e.g., within about the next ten (10) minutes), which warrants the emergency compensation actions described above being applied to the elevator system 20.

In some embodiments of the disclosure, a time stamp can be included with the machine-readable sensor output, and the determination of whether damage to the traveling cable 34 and/or the hoistway structures 26B is imminent can be based on the machine-readable sensor output time stamp. For example, the previously-described “within the next ten (10) minutes” can be computed as within ten (10) minutes from the associated machine-readable sensor output timestamp. In some embodiments of the disclosure, additional time is built into the determination of whether damage to the traveling cable 34 and/or the hoistway structures 26B is imminent to allow sufficient time to execute and complete the elevator control operation (e.g., through the controller 60 and the elevator system 20) that adjusts operations of the elevator system 20 and reduce the movement of the traveling cable 34 within the hoistway 26.

In some embodiments of the disclosure, the M&C system 70 includes machine learning models, which can be machine learning models of the traveling cable 34 in operation. The machine learning models can be trained to perform the tasks of determining that the machine-readable sensor output represents the first operating condition of the traveling cable 34 and/or the second operating condition of the traveling cable 34. In some embodiments of the disclosure, the previously-described operations performed in making the determination that the machine-readable sensor output represents the first operating condition of the traveling cable 34 can be performed using the machine learning models, where the machine learning models generate a prediction that the movement or displacement of the traveling cable 34 within the hoistway 26 will result in future damage to the traveling cable 34, the hoistway structures 26B, or both. The previously-described determination that the machine-readable sensor output represents the first operating condition of the traveling cable 34 can further include the determination that there is enough time to alert an expert to evaluate the elevator system 20 to determine what action, if any should be taken to prevent damage to the traveling cable 34, the hoistway structures 26B, or both.

In some embodiments of the disclosure, the determination that the machine-readable sensor output represents the second operating condition of the traveling cable 34 is a prediction that the movement or displacement of the traveling cable 34 within the hoistway 26 will result in future damage to the traveling cable 34, the hoistway structures 26B, or both. The determination that the machine-readable sensor output represents the second operating condition of the traveling cable 34 further includes a determination that traveling cable sway mitigation actions should be applied to the elevator system 20 immediately because there is not enough time to alert an expert to evaluate the elevator system 20 and the analysis performed by the M&C system 70 to determine what action, if any should be taken to prevent damage to the traveling cable 34, the hoistway structures 26B, or both.

In some embodiments of the disclosure, the determination by the M&C system 70 that the machine-readable sensor output represents the first operating condition of the traveling cable 34 includes a determination that the machine-readable sensor output exceeds a first threshold. In some embodiments of the disclosure, the determination by the M&C system 70 that the machine-readable sensor output represents the second operating condition of the traveling cable 34 condition includes a determination that the machine-readable sensor output exceeds a second threshold.

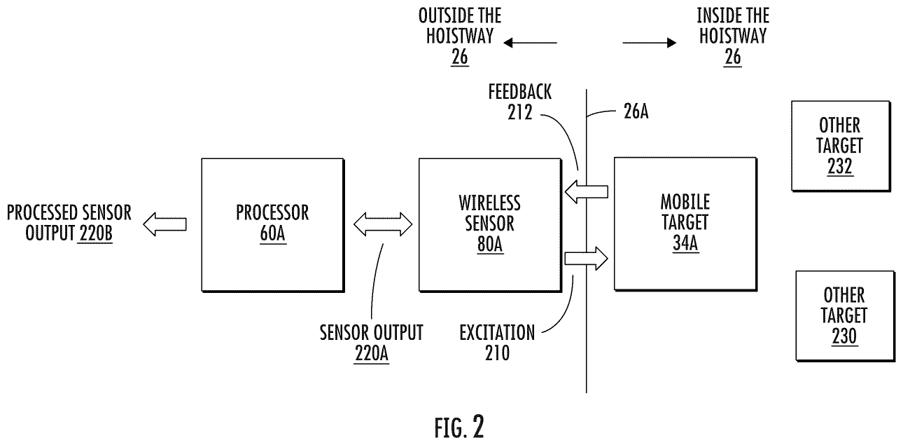

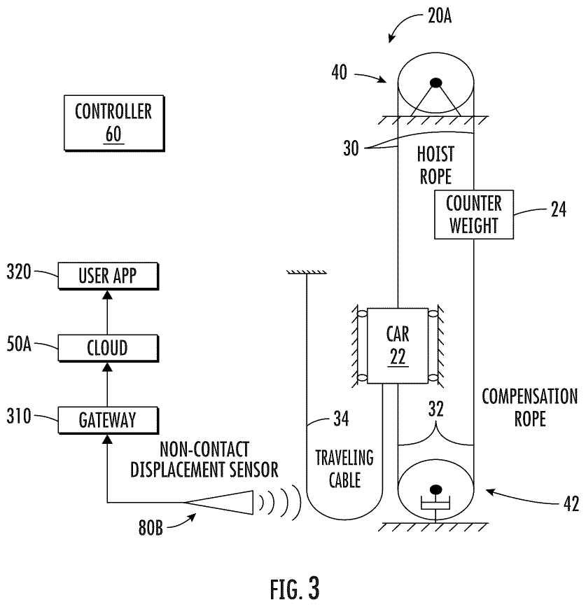

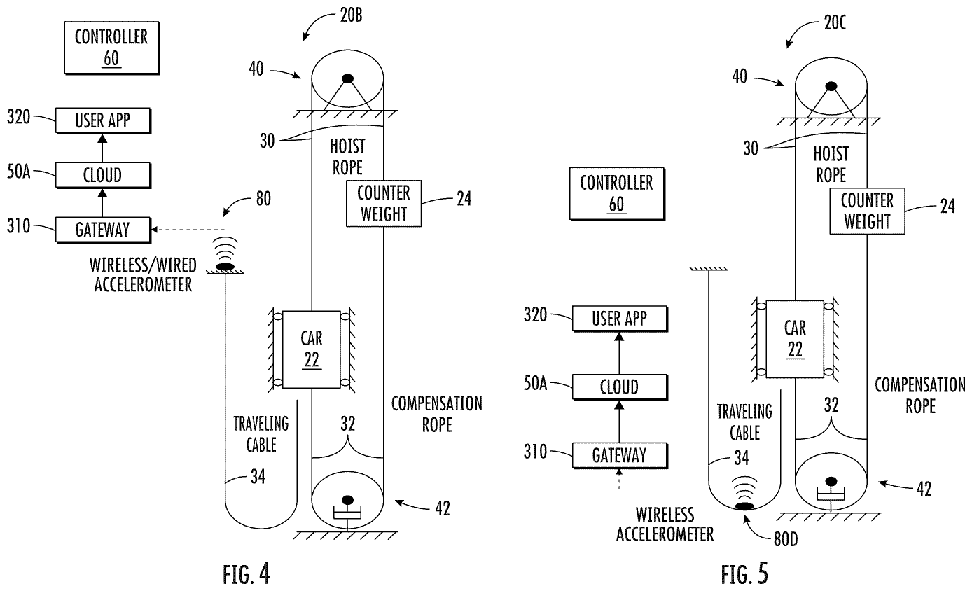

In embodiments of the disclosure, the cable sway sensor 80 can include one or more sensors (not shown separately). The one or more sensors can include, for example, a wireless sensor 80A (shown in FIG. 2), a non-contact displacement sensor 80B (shown in FIG. 3), a wired or wireless accelerometer 80C (shown in FIG. 4), and a wireless accelerometer 80D (shown in FIG. 5). Additional details of the sensors 80A, 80B, 80C, 80D are described in connection with the descriptions of FIGS. 2-5 provided subsequently herein.

Sensors disclosed herein are configured and arranged to detect specific physical phenomena and convert the detected physical phenomenon into machine readable data or information, often for measurement or monitoring purposes. The machine-readable data or information is designed to be understood by machines, thereby enabling efficient data exchange, storage, analysis and interpretation by computers or automated systems without requiring human intervention. The sensors disclosed herein generally include a sensing element and a transducer. The sensing element is operable to detect the specific physical phenomenon (e.g., temperature, pressure, light, motion, chemical composition, and the like) and generate therefrom an interim signal. The transducer is operable to convert the interim signal to the machine-readable data or information, which is machine-readable sensor output.

The machine-readable data or information can be raw machine-readable data or information that require signal processing to improve its quality or usability. Such signal processing can include amplification to boost the signal strength for better readability; filtering to remove noise or irrelevant frequencies from the signal; and linearization that adjusts the signal to ensure that it corresponds linearly to the measured phenomenon. The machine-readable sensor output can be transmitted to a control unit, microcontroller, or data acquisition system, where it can be further processed, displayed, or used to trigger actions. In some instances, the above-described functionality of the transducer can be incorporated into the control unit, microcontroller, or data acquisition system. In some instances, the above-described functionality of the control unit, microcontroller, or data acquisition system can be incorporated within the sensor to form a “smart” sensor.

In some embodiments of the disclosure, the M&C system 70 can optionally take into account machine-readable sensor output from building sway sensors 90, including particularly the operations of the M&C system 70 that train machine learning models/algorithms. The building sway sensors 90 include sensors that operates in a known manner to provide an indication of any existing building sway in the building 10. In a non-limiting example, the building sway sensors 90 include but are not limited to a pendulum-type sensor, a wind anemometer, accelerometers and building tuned mass dampers. In some embodiments of the disclosure, the controller 60 also communicates with the building sway sensors 90 and determines whether a building sway condition exists that is conducive to sway of at least one of the elongated vertical members within the hoistway 26. The controller 60 is programmed to respond to such a condition by selectively controlling operation of the elevator system 20 (and particularly the elevator car 22) to counter or reduce induced sway in one or more of the elongated vertical members within the hoistway 26.

A cloud computing system 50 is in wired or wireless electronic communication with the electronic components (e.g., the controller 60 and the M&C system 70) of the elevator system 20. The cloud computing system 50 can supplement, support or replace some or all of the functionality (in any combination) of the electronic components of the elevator system 20. Additionally, some or all of the functionality of the electronic components (e.g., the controller 60 and the M&C system 70) of the elevator system 20 can be implemented as a node of the cloud computing system 50. In particular with respect to embodiments of the disclosure, some or all of the functionality of the M&C system 70 can be implemented by the cloud computing system 50.

The various components/modules/models of the elevator system 20 (as well as the elevator systems 20A, 20B, 20C shown in FIGS. 3-5) are depicted separately for ease of illustration and explanation. In embodiments of the disclosure, the functions performed by the various components/modules/models can be distributed differently than shown without departing from the scope of the various embodiments of the disclosure described herein unless it is specifically stated otherwise. For example, the functionality of one or more of the M&C system 70 and the cloud computing system 50 can be incorporated in the functionality of the controller 60.

FIG. 2 is a simplified schematic illustration of a wireless sensor 80A that is a non-limiting implementation of the at least one sensor element of the cable sway sensor 80 (shown in FIG. 1) operable to employ the various embodiments of the present disclosure and the features and functionality of the cable sway sensor 80. In some embodiments of the disclosure, the wireless sensor 80A can be positioned outside the hoistway 26 and operable to detect a physical phenomenon of a mobile target 34A positioned inside the hoistway 26. In some embodiments of the disclosure, a non-limiting example implementation of the mobile target 34A is the traveling cable 34 (shown in FIG. 1). In some embodiments of the disclosure, a non-limiting example of the physical phenomenon is displacement measurements of the mobile target 34A from steady state locations. In downstream processing (e.g., at the processor 60A), the displacement measurements can be used along with position signals from the position reference system to determine a proximity of the displaced mobile target 34A to the hoistway wall 26A or to hoistway structures 26B of the hoistway wall 26A.

In some embodiments of the disclosure, the wireless sensor 80A transmits wireless excitation signals 210 (e.g., soundwaves) through the hoistway wall 26A to inside the hoistway 26 where the excitation signals 210 can interact with various targets in the hoistway 26, including the mobile target 34A and other targets 230, 232. In some embodiments of the disclosure, the other targets 230, 232 are also mobile. In some embodiments of the disclosure, more than two of the other targets 230, 232 are provided. In response to the excitation signals 210, the targets 34A, 230, 232 generate feedback signals that can be sensed or otherwise detected by the wireless sensor 80A, where the feedback signals represent a state of the physical phenomenon at the targets 34A, 230, 232.

In some embodiments of the disclosure, the physical phenomenon (e.g., capacitance changes, electromagnetic radiation, and the like) does not require an excitation signal in order to generate the feedback signals, including feedback signal 212. Thus, in some embodiments of the disclosure, the feedback signal 212 is detected by the wireless sensor 80A without the need for an excitation signal 210, and the wireless sensor 80A generates the machine-readable sensor output 220A responsive to detecting the various feedback signals, which include the feedback signal 212 of the mobile targe 34A.

The machine-readable sensor output 220A represents various feedback signals detected at the wireless sensor 80A. In a known manner, the position signals of the position sensor system can be used (e.g., at the processor 60A) to distinguish and isolate the feedback signals 212 generated by the mobile target 34A from the feedback signals generated by the other targets 230, 232. In addition to isolating the feedback signals 212, the processor 60A performs other signal processing operations (e.g., error correction, general noise reduction, and the like) on the machine-readable sensor output 220A to generate processed machine-readable sensor output 220B, which can be provided to the M&C system 70 (shown in FIG. 1) for additional analysis and actions in accordance with embodiments of the disclosure. Thus, the processed machine-readable sensor output 220B represents the current state of a physical phenomenon (e.g., displacement) of the mobile target 34A.

In some embodiments of the disclosure, some or all of the functionality of the processor 60A can be incorporated within the wireless sensor 80A to generate a smart sensor. The adjectives “smart” and/or “connected” are often used to describe the use of computer-based, networked technologies to augment the features of a product or a system. Smart/connected products are embedded with processors, sensors, software, and connectivity that allow data about the product to be gathered, processed, and transmitted to external systems. The data collected from smart/connected products can be analyzed and used to inform decision-making and enable operational efficiencies of the product. The smart sensor implementation of the wireless sensor 80A operates as an Internet of Things (IoT) sensing device. The processor 60A can be implemented to include some or all of the features and functionality of the computer system 1000 (shown in FIG. 10).

FIG. 3 is a simplified schematic illustration of another elevator system 20A operable to employ various embodiments of the present disclosure. Although the hoistway 26, hoistway walls 26A, and hoistway structures 26B are included in the elevator system 20A, they are, for ease of illustration, depicted in the elevator system 20 shown in FIG. 1 but not depicted in the elevator system 20A shown in FIG. 3. The elevator system 20A is substantially the same as the elevator system 20 (shown in FIG. 1) except the cloud computing system 50 (shown in FIG. 1) is implemented as a cloud computing system 50A, and the functionality of the M&C system 70 (shown in FIG. 1) is implemented by the cloud computing system 50A. Additionally, the one or more sensor elements of the cable sway sensor 80 are implemented as at least one non-contact displacement sensor 80B positioned at one or more selected and fixed locations outside the hoistway 26 (shown in FIG. 1). A gateway (or any suitable network interface) 310 enables sending telemetry data from the controller 60 to data centers (e.g., through or at the cloud computing system 50A). In connection with aspects of the disclosure, the gateway (or any suitable network interface) 310 also collects machine-readable sensor outputs from the at least one non-contact displacement sensor 80B and transmits them to the cloud computing system 50A. A user application 320 is operable to be loaded onto a computing system (e.g., a mobile device, tablet or personal computer) utilized by an expert. The previously-described alerts can be transmitted to the user application 320, which conveys the alert to the expert/user.

In embodiments of the disclosure, the at least one non-contact displacement sensor 80B is a non-limiting example implementation of the wireless sensor 80A (shown in FIG. 2) and can include all of the functionality and features of the wireless sensor 80A. The non-contact displacement sensor is positioned at a substantially fixed location outside the hoistway 26 and sufficiently close to the various positions of the traveling cable 34 to receive feedback signals from the traveling cable 34 in all positions of the traveling cable 34. The non-contact displacement sensor 80B operates by measuring the distance to the traveling cable 34 without physically touching it. The measured distance is supplied through the gateway 310 to the cloud computing system 50A which uses measured distance to perform the features and functionality of the M&C system 70, which in the elevator system 20A is performed at the cloud 50A, which corresponds to the cloud computing system 50 (shown in FIG. 1).

FIG. 4 is a simplified schematic illustration of another elevator system 20B operable to employ various embodiments of the present disclosure. Although the hoistway 26, hoistway walls 26A, and hoistway structures 26B are included in the elevator system 20B, they are, for ease of illustration, depicted in the elevator system 20 shown in FIG. 1 but not depicted in the elevator system 20B shown in FIG. 4. The elevator system 20B is substantially the same as the elevator system 20A (shown in FIG. 3) except the non-contact displacement sensor 80B is replaced with a wired or wireless accelerometer 80C mechanically coupled through the hoistway wall 26A to an end region of the traveling cable 34 that attaches to the hoistway wall 26. The accelerometer 80C is wired or wireless in that the accelerometer 80C can be in wired or wireless communication with the gateway 310.

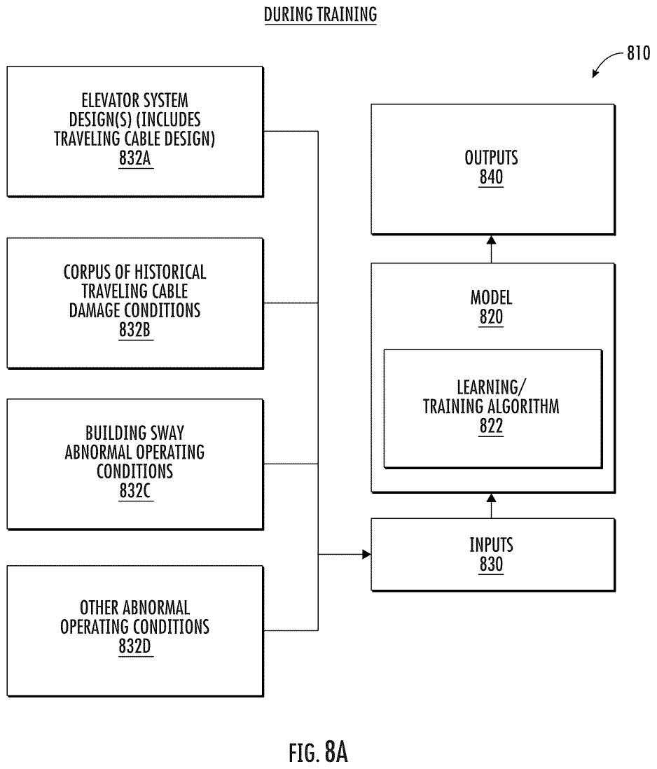

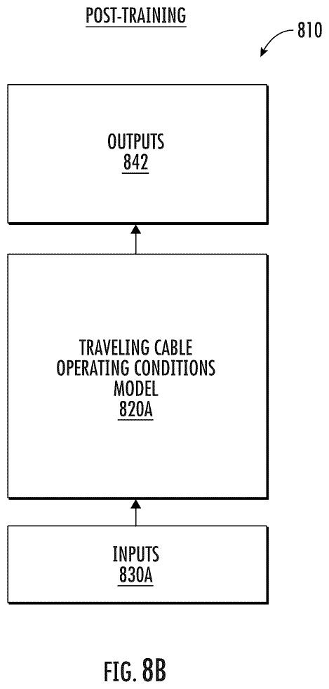

The wired/wireless accelerometer 80C measures acceleration of the traveling cable 34, which is the rate of change of velocity of the traveling cable 34. Specifically, the wired/wireless accelerometer 80C can detect changes in vibration, speed and direction of motion of the traveling cable 34. In general, accelerometers employ data analysis/processing techniques that use X, Y, and Z coordinates to measure motion by detecting acceleration along three orthogonal axes, taking into account the orientation of the object being measured. This multi-axis measurement allows accelerometers to capture the full range of a target object's movement in three-dimensional space, and also allows accelerometers to focus on particular movements of one or more target objects in a group of objects by focusing on a particular axis or axes that represent the particular movements that are being measured (e.g., lateral displacement of the traveling cable 34). By being physically attached through the hoistway wall 26A to a fixed end region of the traveling cable 34 that attaches to the hoistway wall 26, the wired/wireless accelerometer 80C measures acceleration/movement in the movable regions of the traveling cable 34 to provide measurements that represent how the moving parts of the traveling cable 34 behaves in relation to the whole structure. The readings from the wired/wireless accelerometer 80C can be combined with knowledge about the mechanics of the elevator system 20B to infer the movements of the movable parts. In accordance with embodiments of the disclosure, additional calculations or modeling (e.g., FIGS. 7A, 7B, 8A, and 8B described subsequently herein) are used to relate the readings from the wired/wireless accelerometer 80C to the task of predicting the previously-described first operating conditions and second operating conditions of the traveling cable 34.

FIG. 5 is a simplified schematic illustration of another elevator system 20C operable to employ various embodiments of the present disclosure. Although the hoistway 26, hoistway walls 26A, and hoistway structures 26B are included in the elevator system 20C, they are, for ease of illustration, depicted in the elevator system 20 shown in FIG. 1 but not depicted in the elevator system 20C shown in FIG. 5. The elevator system 20C is substantially the same as the elevator system 20B (shown in FIG. 4) except the wired/wireless accelerometer 80C is replaced with a wired/wireless accelerometer 80D mechanically coupled to the traveling cable 34 such that it experiences the movements of the traveling cable 34. The accelerometer 80D is wired or wireless in that the accelerometer 80D can be in wired or wireless communication through the hoistway wall 26A with the gateway 310.

The wired/wireless accelerometer 80D measures acceleration of the traveling cable 34, which is the rate of change of velocity of the traveling cable 34. Specifically, the wired/wireless accelerometer 80D can detect changes in vibration, speed and direction of motion of the traveling cable 34. In general, accelerometers employ data analysis/processing techniques that use X, Y, and Z coordinates to measure motion by detecting acceleration along three orthogonal axes, taking into account the orientation of the object being measured. This multi-axis measurement allows accelerometers to capture the full range of a target object's movement in three-dimensional space, and also allows accelerometers to focus on particular movements of one or more target objects in a group of objects by focusing on a particular axis or axes that represent the particular movements that are being measured (e.g., lateral displacement of the traveling cable 34). By being physically attached to the traveling cable 34, the wired/wireless accelerometer 80D measures acceleration/movement in the movable regions of the traveling cable 34 to provide measurements that represent how the moving parts of the traveling cable 34 behave in relation to the whole structure. The readings from the wired/wireless accelerometer 80D can be combined with knowledge about the mechanics of the elevator system 20C to infer the movements of the movable parts. In accordance with embodiments of the disclosure, additional calculations or modeling (e.g., FIGS. 7A, 7B, 8A, and 8B described subsequently herein) are used to relate the readings from the wired/wireless accelerometer 80D to the task of predicting the previously-described first operating conditions and second operating conditions of the traveling cable 34.

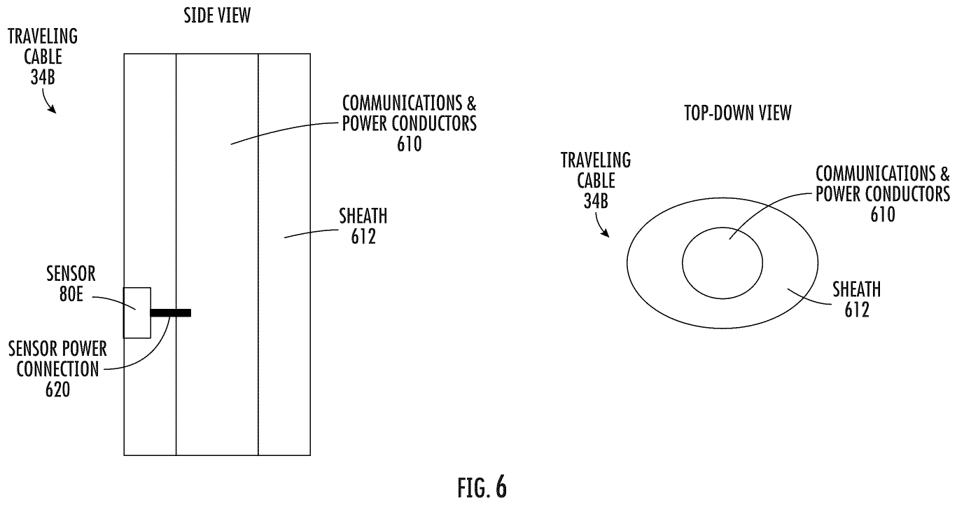

FIG. 6 is a simplified schematic illustration of a traveling cable 34B operable to employ various embodiments of the present disclosure. The traveling cable 34B is a non-limiting example of how the traveling cable 34 and/or the moving target 34A can be implemented in accordance with some embodiments of the disclosure. FIG. 6 depicts a cross-sectional side view of the traveling cable 34B, along with a top-down view of the traveling cable 34B. The traveling cable 34B can be constructed from materials designed to ensure durability, flexibility, and effective traveling cable performance, including communications and power conductors 610, insulation (not shown separately) and a sheath 612. The conductors 610 can be metals (e.g., copper, aluminum, and the like) suitable for use as electrical conductors of power and communications signals due to their conductivity, flexibility, and corrosion resistance. The conductors 610 can be stranded (i.e., made up of multiple smaller wires) to enhance flexibility and reduce the risk of breakage during movement. The insulation (not shown separately) can include polyvinyl chloride (PVC), thermoplastic elastomers (TPE), or cross-linked polyethylene (XLPE). The sheath 612 is an outer shell that can be formed from durable materials (e.g., PVC or polyurethane) that protect the internal conductors 610 and insulation (not shown separately) from abrasion and environmental factors.

In accordance with aspects of the disclosure, a sensor 80E, which can be a complete sensing system or the sensing element of a sensing system, is physically attached to the sheath 612 and electronically coupled through a sensor power connection 620 to the conductors 610. In some embodiments of the disclosure, the sensor 80E is completely embedded, partially embedded, or attached to a surface of the sheath 612. In some embodiments of the disclosure, the sensor 80E can be partially or completely battery powered. In some embodiments of the disclosure, the sensor batteries can be rechargeable, and specifically rechargeable through the power sensor connection 620 to the conductors 610. In some embodiments of the disclosure, the sensor 80E can be implemented as the accelerometer 80D (shown in FIG. 5). The need to replace the sensor 80E because of battery power loss can be eliminated by providing power to the sensor 80E directly from the communications & power conductor 610 and/or through rechargeable implementations of the sensor battery.

The sensor systems and sensor elements 80, 80A, 80B, 80C, 80D, 80E include the capability to communicate wirelessly. Suitable wireless communications strategies and techniques used herein can apply protocols that include local area network (LAN, or WLAN for wireless LAN) protocols and/or a private area network (PAN) protocols. LAN protocols include WiFi technology, based on the Section 802.11 standards from the Institute of Electrical and Electronics Engineers (IEEE). PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

FIG. 7A is a flow diagram illustrating a computer-implemented methodology 700 in accordance with embodiments of the disclosure; and FIG. 7B is a simplified schematic 730 further illustrating aspects of the methodology 700 shown in FIG. 7A. The following description of the methodology 700 makes primary reference to the methodology 700 shown in FIG. 7A, with supplemental reference to corresponding aspects of the simplified schematic 730 shown in FIG. 7B.

Referring now to FIG. 7A, the methodology 700 can be implemented using one or more of the electronic control elements (e.g., cloud computing systems 50, cloud 50A, controllers 60, processors 60A, gateways (or other suitable network interfaces) 310, user applications (user apps) 320, and M&C system 70) of the elevator systems 20, 20A, 20B, 20C described herein. The methodology 700 starts at block 702 and moves to block 704 to monitor traveling cable movement (TCM) information, which can take the form of the various machine-readable sensor outputs described herein (e.g., machine-readable sensor output 220A and/or processed machine-readable sensor output 220B shown in FIG. 2). In accordance with embodiments of the disclosure, the machine-readable sensor output has been generated responsive to movement of a traveling cable (e.g., traveling cable 34) within an elevator hoistway (e.g., hoistway 26).

The methodology 700 moves substantially in parallel to decision block 706 and decision block 712. Decision block 706 evaluates whether or not the TCM information monitored at block 704 is sufficient to satisfy the conditions for executing the previously-described alert operation. In embodiments of the disclosure, the conditions for executing the previously-described alert operation correspond to the previously-described first operating condition of the traveling cable. If the answer to the inquiry at decision block 706 is no, the TCM information monitored at block 704 is insufficient to satisfy the conditions for generating the previously-described alert operation, and the associated elevator system is operating under normal elevator system operating conditions (e.g., as shown in the leftmost column of diagram in FIG. 7B). Under normal elevator system operating conditions, the TCM information reflects that the traveling cable is experiencing vibrations, movement (e.g., sway) and bending that are insufficient to bring the traveling cables into contact with hoistway walls or hoistway structures, which can cause damage to the traveling cables, the hoistway structures, or both. The leftmost column of the simplified schematic 730 in FIG. 7B illustrates this TCM information status as TCM-range-0, where no alerts operations are executed, and no elevator system compensation is executed. The leftmost column of the simplified schematic 730 in FIG. 7B also illustrates this TCM information status as corresponding to a traveling cable operation condition identified as Traveling Cable Operating Condition-0. If the answer to the inquiry at decision block 706 is no, the methodology 700 moves to block 710 and, if TCM alerts and/or TCM compensations are active (e.g., from previous iterations of the methodology 700), the alerts and compensations are discontinued. The methodology 700 returns to block 704 to continue monitoring TCM information.

If the answer to the inquiry at decision block 706 is yes, the TCM information monitored at block 704 is sufficient to satisfy the conditions for generating the previously-described alert operation, and the associated elevator system is operating under a first type of abnormal elevator system operating condition, which is marked as “Abnormal-1 Elevator System Operation” and shown in the center column of the simplified schematic 730 of FIG. 7B. Under abnormal-1 elevator system operating conditions, the TCM information reflects that the traveling cable is experiencing vibrations, movement (e.g., sway) and/or bending that, if they continue on their current trajectory (or at their current rate), will become sufficient to cause the traveling cable to contact hoistway walls and/or hoistway structures and cause damage to hoistway structure, the traveling cables, or both. Decision block 706 further determines that the rate of increase in the vibrations, movement (e.g., sway) and/or bending induced by the abnormal-1 elevator system operation is low enough that there is time (e.g., about two (2) hours or more) to execute the previously described alert operations and have an expert investigate the state of the traveling cable before the traveling cable contacts hoistway walls and hoistway structures. The center column of the simplified schematic 730 in FIG. 7B illustrates this TCM information status as TCM-range-1, where alerts are executed, and no elevator system compensation is executed. The center column of the simplified schematic 730 in FIG. 7B also illustrates this TCM information status as corresponding to a traveling cable operation condition identified as Traveling Cable Operating Condition-1. Responsive to the “yes” determination at decision block 706, the methodology 700 moves to block 708 and executes and/or maintains TCM alerts.

In some embodiments of the disclosure, the determination at block 706 as to whether or not the TCM information reflects that the associated elevator system is operating under normal or abnormal-1 elevator system operating conditions (e.g., as shown in the center column of the simplified schematic 730 in FIG. 7B) includes a determination of whether or not the TCM information exceeds a first threshold, which corresponds to the previously-described determination of whether or not the machine-readable sensor output exceeds the previously-described first threshold.

In some embodiments of the disclosure, the determination at block 706 as to whether or not the TCM information reflects that the associated elevator system is operating under normal or abnormal-1 elevator system operating conditions (e.g., as shown in the center column of the simplified schematic 730 in FIG. 7B) includes using the previously-described machine learning models of the M&C system 70 (shown in FIG. 1). The machine learning models of the M&C system 70 can be machine learning models of the traveling cable 34 trained to perform the tasks of determining that the TCM information (i.e., the machine-readable sensor output) represents the first operating condition, which corresponds to the abnormal-1 elevator system operating conditions (e.g., as shown in the center column of the simplified schematic 730 in FIG. 7B). Thus, the previously described machine learning operations of the M&C system 70 can be used to perform the operations at decision block 706.

As previously-noted, the TCM information monitored at block 704 is also provided to decision block 712. At decision block 712, the methodology 700 evaluates whether or not the TCM information monitored at block 704 is sufficient to satisfy the conditions for initiating a TCM compensation action. In some embodiments of the disclosure, the determination at decision block 712 of whether or not the TCM information is sufficient to satisfy the conditions for initiating a TCM compensation action (e.g., abnormal-2 elevator system operating conditions shown in the rightmost column of the simplified schematic 730 of FIG. 7B) includes a determination of whether or not the TCM information exceeds a second threshold.

In some embodiments of the disclosure, the evaluation by the methodology 700 of whether or not the TCM information monitored at block 704 is sufficient to satisfy the conditions for initiating a TCM compensation action corresponds to (and can be implemented by) the previously-described determination performed by the M&C system 70 that the machine-readable sensor output (i.e., TCM information) represents a second operating condition of the traveling cable (e.g., abnormal-2 elevator system operating conditions shown in the rightmost column of the simplified schematic 730 of FIG. 7B) that warrants the M&C system 70 executing elevator control operation (e.g., a TCM compensation action) operable to reduce the movement of the traveling cable within the hoistway to compensate for displacement (or sway) of the traveling cable.

If the answer to the inquiry at decision block 712 is no, the TCM information monitored at block 704 is insufficient to satisfy the conditions for determining that TCM compensation is warranted, although, based on results of the evaluation at decision block 706, the associated elevator system could be operating under abnormal-1 elevator system operating conditions (e.g., abnormal-1 elevator system operating conditions shown in the central column of the simplified schematic 730 of FIG. 7B). Responsive to a “no” response to the inquiry at decision block 712, the methodology 700 moves to block 716 and, if TCM alerts were activated at decision block 706, block 716 maintains the TCM the alerts, and the methodology 700 returns to block 704 to continue monitoring TCM information.

If the answer to the inquiry at decision block 712 is yes, the methodology 700 moves substantially in parallel to block 714 and decision block 718. At block 714, the methodology 700 executes and/or maintains the TCM compensation operations. At decision block 718, the methodology 700 determines whether or not the methodology 700 has received an interrupt command. If the answer to the inquiry at decision block 718 is yes, the methodology 700 moves to block 720 to interrupt the TCM alerts and/or the TCM compensations and end the methodology 700. If the answer to the inquiry at decision block 718 is no, the methodology 700 returns to block 704 to continue monitoring TCM information and perform another iteration of the methodology 700.

Some embodiments of the disclosure utilize machine learning models trained to perform the tasks of determining whether or not the machine-readable sensor output (e.g., TCM information) corresponds to or predicts the previously-described first type of traveling cable operating condition. Some embodiments of the disclosure further utilize machine learning models trained to perform the tasks of determining whether or not the machine-readable sensor output (e.g., TCM information) corresponds to or predicts the previously-described second type of traveling cable operating condition. FIG. 8A depicts a simplified block diagram of a system 810 operable to train a model 820 to generate outputs 840, which are a classification or prediction of the existence of the previously-described first type of traveling cable operating condition and/or a classification or prediction of the existence of the previously-described second type of traveling cable operating condition.

As shown, the training operation performed by the system 810 includes supplying inputs 830 to the model 820, and applying a learning/training algorithm 822 to the inputs 830 to generate outputs 840. In accordance with embodiments of the disclosure, the inputs 830 during training are various forms of labeled or unlabeled training data (blocks 832A, 832B, 832C, 832D), the learning/training algorithm 822 is any suitable learning methodology for training the model 820, and the outputs 840 are the classifications and/or predictions generated by model 820 during training. In accordance with embodiments of the system 810, block 832A is training data on one or more elevator system designs (including traveling cable designs) that are the same as or similar to the elevator system currently being monitored; block 832B is training data on a corpus of historical traveling cable damage conditions (including traveling cables and elevator systems that are similar to the traveling cable and elevator system currently being evaluated); optionally, block 832C is training data on building-sway-type abnormal operating conditions (e.g., as assembled through building sway sensors such as the building sway sensors 90 shown in FIG. 1); and block 832D is training data on the characteristics and features of “other” abnormal operating conditions (e.g., the piston effect and/or the stack effect) (including the elevator system operating conditions that induce “other” abnormal operating conditions).

FIG. 8B depicts a machine learning model 820A, post-training, which is the model 820 (shown in FIG. 8A) after the training has been completed. The model 820A is obtained via performance of the training of FIG. 8A and includes a machine learning prediction model operable to perform the various determinations described herein in accordance with embodiments of the disclosure. In response to inputs 830A (e.g., machine-readable sensor outputs), the prediction model 820A generates outputs 842, which are predictions of whether or not the traveling cable that generated the machine-readable sensor outputs represent normal elevator system operation, abnormal-1 elevator system operation, or abnormal-2 elevator system operation.

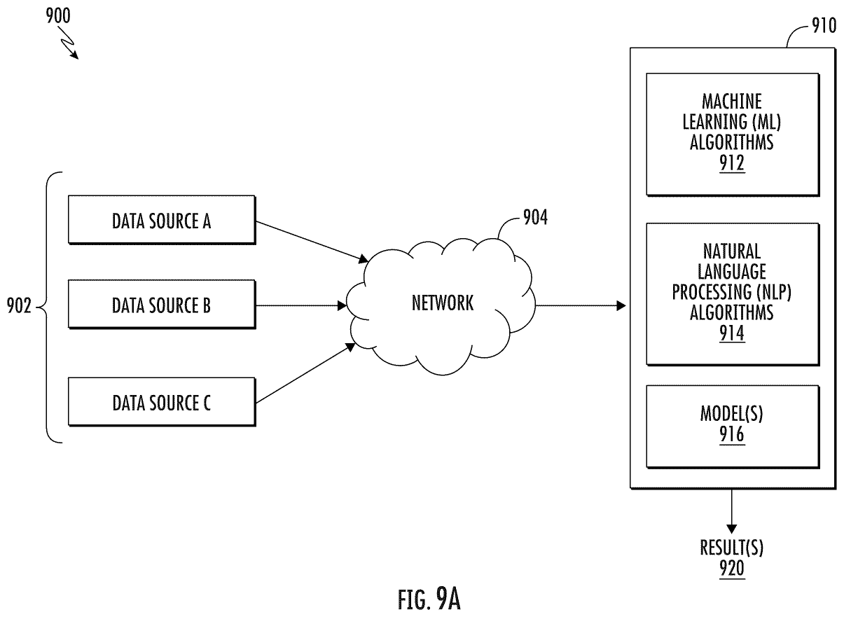

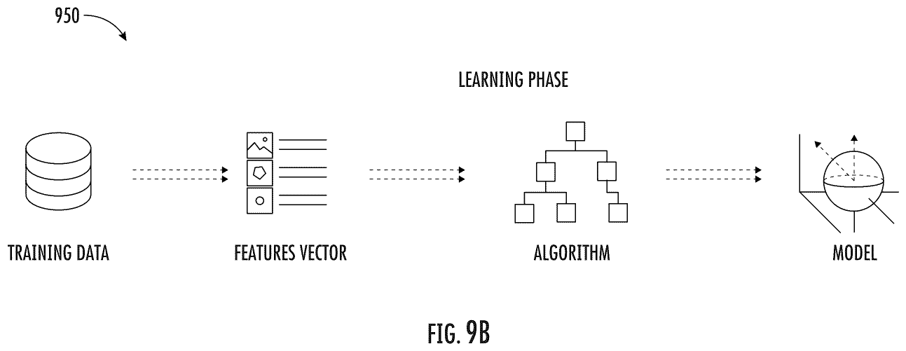

Additional details of example of machine learning techniques that can be used to implement aspects of the disclosure will be described with reference to FIGS. 9A and 9B. Machine learning models configured and arranged according to embodiments of the disclosure will be described with reference to FIG. 9A.

FIG. 9A depicts a block diagram showing a machine learning or classifier system 900 capable of implementing various aspects of the disclosure described herein. More specifically, the functionality of the system 900 is used in embodiments of the disclosure to generate various models and sub-models that can be used to implement computer functionality in embodiments of the disclosure. The system 900 includes multiple data sources 902 in communication through a network 904 with a classifier 910. In some aspects of the disclosure, the data sources 902 can bypass the network 904 and feed directly into the classifier 910. The data sources 902 provide data/information inputs that will be evaluated by the classifier 910 in accordance with embodiments of the disclosure. The data sources 902 also provide data/information inputs that can be used by the classifier 910 to train and/or update model(s) 916 created by the classifier 910. The data sources 902 can be implemented as a wide variety of data sources, including but not limited to, sensors configured to gather real time data, data repositories (including training data repositories), and outputs from other classifiers. The network 904 can be any type of communications network, including but not limited to local networks, wide area networks, private networks, the Internet, and the like.

The classifier 910 can be implemented as algorithms executed by a programmable computer such as a computer system 1000 (shown in FIG. 11). As shown in FIG. 9A, the classifier 910 includes a suite of machine learning (ML) algorithms 912; natural language processing (NLP) algorithms 914; and model(s) 916 that are relationship (or prediction) algorithms generated (or learned) by the ML algorithms 912. The algorithms 912, 914, 916 of the classifier 910 are depicted separately for ease of illustration and explanation. In embodiments of the disclosure, the functions performed by the various algorithms 912, 914, 916 of the classifier 910 can be distributed differently than shown. For example, where the classifier 910 is configured to perform an overall task having sub-tasks, the suite of ML algorithms 912 can be segmented such that a portion of the ML algorithms 912 executes each sub-task and a portion of the ML algorithms 912 executes the overall task. Additionally, in some embodiments of the disclosure, the NLP algorithms 914 can be integrated within the ML algorithms 912.

The NLP algorithms 914 include speech recognition functionality that allows the classifier 910, and more specifically the ML algorithms 912, to receive natural language data (text and audio) and apply elements of language processing, information retrieval, and machine learning to derive meaning from the natural language inputs and potentially take action based on the derived meaning. The NLP algorithms 914 used in accordance with aspects of the disclosure can also include speech synthesis functionality that allows the classifier 910 to translate the result(s) 920 into natural language (text and audio) to communicate aspects of the result(s) 920 as natural language communications.

The NLP and ML algorithms 914, 912 receive and evaluate input data (i.e., training data and data-under-analysis) from the data sources 902. The ML algorithms 912 includes functionality that is necessary to interpret and utilize the input data's format. For example, where the data sources 902 include image data, the ML algorithms 912 can include visual recognition software configured to interpret image data. The ML algorithms 912 apply machine learning techniques to received training data (e.g., data received from one or more of the data sources 902) in order to, over time, create/train/update one or more models 916 that model the overall task and the sub-tasks that the classifier 910 is designed to complete.

Referring now to FIGS. 9A and 9B collectively, FIG. 9B depicts an example of a learning phase 950 performed by the ML algorithms 912 to generate the above-described models 916. In the learning phase 950, the classifier 910 extracts features from the training data and coverts the features to vector representations that can be recognized and analyzed by the ML algorithms 912. The features vectors are analyzed by the ML algorithm 912 to “classify” the training data against the target model (or the model's task) and uncover relationships between and among the classified training data. Examples of suitable implementations of the ML algorithms 912 include but are not limited to neural networks, support vector machines (SVMs), logistic regression, decision trees, hidden Markov Models (HMMs), etc. The learning or training performed by the ML algorithms 912 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier 910 and the ML algorithms 912. Unsupervised learning can utilize additional learning/training methods including, for example, clustering, anomaly detection, neural networks, deep learning, and the like.

When the models 916 are sufficiently trained by the ML algorithms 912, the data sources 902 that generate “real world” data are accessed, and the “real world” data is applied to the models 916 to generate usable versions of the results 920. In some embodiments of the disclosure, the results 920 can be fed back to the classifier 910 and used by the ML algorithms 912 as additional training data for updating and/or refining the models 916.

In aspects of the disclosure, the ML algorithms 912 and the models 916 can be configured to apply confidence levels (CLs) to various ones of their results/determinations (including the results 920) in order to improve the overall accuracy of the particular result/determination. When the ML algorithms 912 and/or the models 916 make a determination or generate a result for which the value of CL is below a predetermined threshold (TH) (i.e., CL<TH), the result/determination can be classified as having sufficiently low “confidence” to justify a conclusion that the determination/result is not valid, and this conclusion can be used to determine when, how, and/or if the determinations/results are handled in downstream processing. If CL>TH, the determination/result can be considered valid, and this conclusion can be used to determine when, how, and/or if the determinations/results are handled in downstream processing. Many different predetermined TH levels can be provided. The determinations/results with CL>TH can be ranked from the highest CL>TH to the lowest CL>TH in order to prioritize when, how, and/or if the determinations/results are handled in downstream processing.

In aspects of the disclosure, the classifier 910 can be configured to apply confidence levels (CLs) to the results 920. When the classifier 910 determines that a CL in the results 920 is below a predetermined threshold (TH) (i.e., CL<TH), the results 920 can be classified as sufficiently low to justify a classification of “no confidence” in the results 920. If CL>TH, the results 920 can be classified as sufficiently high to justify a determination that the results 920 are valid. Many different predetermined TH levels can be provided such that the results 920 with CL>TH can be ranked from the highest CL>TH to the lowest CL>TH.

FIG. 10 illustrates an example of a computer system 1000 that can be used to implement the computer-based components in accordance with aspects of the disclosure. The computer system 1000 includes an exemplary computing device (“computer”) 1002 configured for performing various aspects of the electronic control operations described herein in accordance with aspects of the disclosure. In addition to computer 1002, the exemplary computer system 1000 includes network 1014, which connects computer 1002 to additional systems (not depicted) and can include one or more wide area networks (WANs) and/or local area networks (LANs) such as the Internet, intranet(s), and/or wireless communication network(s). Computer 1002 and additional system are in communication via network 1014, e.g., to communicate data between them.

Exemplary computer 1002 includes processor cores 1004, main memory (“memory”) 1010, and input/output component(s) 1012, which are in communication via bus 1003. Processor cores 1004 include cache memory (“cache”) 1006 and controls 1008, which include branch prediction structures and associated search, hit, detect and update logic, which will be described in more detail below. Cache 1006 can include multiple cache levels (not depicted) that are on or off-chip from processor 1004. Memory 1010 can include various data stored therein, e.g., instructions, software, routines, etc., which, e.g., can be transferred to/from cache 1006 by controls 1008 for execution by processor 1004. Input/output component(s) 1012 can include one or more components that facilitate local and/or remote input/output operations to/from computer 1002, such as a display, keyboard, modem, network adapter, etc. (not depicted).

A cloud computing system 50 is in wired or wireless electronic communication with the computer system 1000. The cloud computing system 50 can supplement, support or replace some or all of the functionality (in any combination) of the computer system 1000. Additionally, some or all of the functionality of the computer system 1000 can be implemented as a node of the cloud computing system 50.

For the sake of brevity, conventional techniques related to making and using aspects of the disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Similarly, conventional techniques related to device fabrication operations may or may not be described in detail herein. Moreover, the various tasks and process steps described herein can be incorporated into a more comprehensive procedure or process having additional steps or functionality not described in detail herein. In particular, various steps in the manufacture of devices described herein are well known and so, in the interest of brevity, many conventional steps will only be mentioned briefly herein or will be omitted entirely without providing the well-known process details.

Some functional units of the systems described in this specification can be implemented as modules. Embodiments of the disclosure apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

The various components/modules/models of the systems illustrated herein are depicted separately for ease of illustration and explanation. In embodiments of the disclosure, the functions performed by the various components/modules/models can be distributed differently than shown without departing from the scope of the various embodiments of the disclosure describe herein unless it is specifically stated otherwise.

Various embodiments of the disclosure are described herein with reference to the related drawings. Alternative embodiments of the disclosure can be derived without departing from the scope of this disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value. Additionally, the terms “about,” “substantially,” “approximately,” and variations thereof, refer to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

Each computer, controller or other processor-based component identified herein can be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein can be but is not limited to a random access memory (RAM), read only memory (ROM), or other electronic, optical, magnetic or any other computer readable medium. Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

Aspects of the disclosure can be embodied as a system, a method, and/or a computer program product at any possible technical detail level of integration. The computer program product can include a computer readable storage medium (or media) having computer readable program instructions thereon for causing a processor to carry out aspects of the present disclosure.

What is claimed is:

1. A controller for monitoring and controlling an elevator system, wherein the controller is operable to perform controller operations comprising:
receiving machine-readable sensor output generated in response to movement of a traveling cable within a hoistway;
analyzing the machine-readable sensor output to determine a traveling cable operating condition;
responsive to a determination that the traveling cable operating condition comprises a first type of traveling cable operating condition, executing an alert operation; and
responsive to a determination that the traveling cable operating condition comprises a second type of traveling cable operating condition, executing an elevator control operation operable to reduce the movement of the traveling cable within the hoistway.

2. The controller of claim 1, wherein the machine-readable sensor output is generated by a sensor physically coupled to the traveling cable.

3. The controller of claim 2, wherein the sensor receives power from a power conductor of the traveling cable.

4. The controller of claim 1, wherein the machine-readable sensor output is generated by a non-contact displacement sensor.

5. The controller of claim 1, wherein:
the machine-readable sensor output is generated by a sensor;
a first end of the traveling cable is electronically coupled to an elevator car of the elevator system; and
a second end of the traveling cable is physically coupled to the sensor.

6. The controller of claim 1, wherein the controller comprises a machine learning model.

7. The controller of claim 6, wherein:
the determination that the traveling cable operating condition comprises the first type of traveling cable operating condition is performed by the machine learning model; and
the determination that the traveling cable operating condition comprises the first type of traveling cable operating condition comprises a first prediction of a first type of future movement of the traveling cable within the hoistway.

8. The controller of claim 7, wherein:
the determination that the traveling cable operating condition comprises the second type of traveling cable operating condition is performed by the machine learning model; and
the determination that the traveling cable operating condition comprises the second type of traveling cable operating condition comprises:
a second prediction of a second type of movement of the traveling cable within the hoistway; and
a third prediction that the second type of movement of the traveling cable within the hoistway will result in damage to the traveling cable.

9. The controller of claim 1, wherein the determination that the traveling cable operating condition comprises the first type of traveling cable operating condition comprises a determination that the machine-readable sensor output exceeds a first threshold.

10. The controller of claim 9, wherein the determination that the traveling cable operating condition comprises the second type of traveling cable operating condition comprises a determination that the machine-readable sensor output exceeds a second threshold.

11. An elevator system comprising:
a traveling cable physically and electronically coupled to an elevator car, wherein the traveling cable and the elevator car are configured to operate within a hoistway; and
a controller operable to perform controller operations comprising:
receiving machine-readable sensor output generated in response to movement of the traveling cable within the hoistway;
analyzing the machine-readable sensor output to determine a traveling cable operating condition;
responsive to a determination that the traveling cable operating condition comprises a first type of traveling cable operating condition, executing an alert operation; and
responsive to a determination that the traveling cable operating condition comprises a second type of traveling cable operating condition, executing an elevator control operation operable to reduce the movement of the traveling cable within the hoistway.

12. The elevator system of claim 11, wherein:
the machine-readable sensor output is generated by a sensor;
the sensor receives power from a power conductor of the traveling cable; and
the sensor is selected from the group consisting of a displacement sensor and an accelerometer.

13. The elevator system of claim 11, wherein:
the machine-readable sensor output is generated by a sensor; and
the sensor comprises an accelerometer.

14. The elevator system of claim 11, wherein:
the controller comprises a machine learning model;
the determination that the traveling cable operating condition comprises the first type of traveling cable operating condition is performed by the machine learning model;
the determination that the traveling cable operating condition comprises the first type of traveling cable operating condition comprises a first prediction of a first future movement of the traveling cable within the hoistway;
the determination that the traveling cable operating condition comprises the second type of traveling cable operating condition is performed by the machine learning model; and
the determination that the traveling cable operating condition comprises the second type of traveling cable operating condition comprises:
a second prediction of a second type of movement of the traveling cable within the hoistway; and
a third prediction that the second type of movement of the traveling cable within the hoistway will result in damage to the traveling cable.

15. The elevator system of claim 11, wherein:
the determination that the traveling cable operating condition comprises the first type of traveling cable operating condition comprises a determination that the machine-readable sensor output exceeds a first threshold;
the determination that the traveling cable operating condition comprises the second type of traveling cable operating condition comprises a determination that the machine-readable sensor output exceeds a second threshold; and
the first threshold is less than the second threshold.

16. A computer-implemented method comprising:
receiving, using a processor system, machine-readable sensor output generated in response to movement of a traveling cable within a hoistway;
analyzing the machine-readable sensor output to determine a traveling cable operating condition;
responsive to a determination that the traveling cable operating condition comprises a first type of traveling cable operating condition, executing an alert operation; and
responsive to a determination that the traveling cable operating condition comprises a second type of traveling cable operating condition, executing an elevator control operation operable to reduce the movement of the traveling cable within the hoistway.

17. The computer-implemented method of claim 16, wherein the machine-readable sensor output is generated by a sensor selected from the group consisting of a displacement sensor and an accelerometer.

18. The computer-implemented method of claim 16, wherein:
the processor system comprises a machine learning model;
the determination that the traveling cable operating condition comprises the first type of traveling cable operating condition is performed by the machine learning model;
the determination that the traveling cable operating condition comprises the first type of traveling cable operating condition comprises a first prediction of a first future movement of the traveling cable within the hoistway;
the determination that the traveling cable operating condition comprises the second type of traveling cable operating condition is performed by the machine learning model; and
the determination that the traveling cable operating condition comprises the second type of traveling cable operating condition comprises:
a second prediction of a second type of movement of the traveling cable within the hoistway; and
a third prediction that the second type of movement of the traveling cable within the hoistway will result in damage to the traveling cable.

19. The computer-implemented method of claim 16, wherein the determination that the traveling cable operating condition comprises the first type of traveling cable operating condition comprises a determination that the machine-readable sensor output exceeds a first threshold.

20. The computer-implemented method of claim 19, wherein the determination that the traveling cable operating condition comprises the second type of traveling cable operating condition comprises a determination that the machine-readable sensor output exceeds a second threshold.
